(19) United States
(12) Patent Application Publication
(10) Pub. No.: US 2012/0199709 A1
(43) Pub. Date: Aug. 9, 2012

(54) TILE-READY STRUCTURAL SUPPORT LEDGE FOR CERAMIC TILE SHELVES

(76) Inventor: Wade D. Rompel, Folsom, CA (US)

(21) Appl. No.: 13/020,219

(22) Filed: Feb. 3, 2011

(51) Int. Cl. F16B 47/00; F16M 13/02

(52) U.S. Cl. 248/205.4; 248/224.8

(57) ABSTRACT

A corrosion-resistant self supporting ledge of a pre-formed shape, to which a bonding agent and ceramic tile is applied, in order to produce wall shelves for the purpose of storing or displaying objects. The base unit (1) connects to vertical surfaces by fasteners through mounting holes (3) which penetrate the integral mounting flange (2). Finish materials (5) are adhered to the base unit (1) and/or integral mounting flange (2) by way of adhesive penetration holes (4) and applied bonding agent (6).

### BACKGROUND

1. Field of Invention

This invention relates to customizable ceramic tile shelves used with a job-site applied finish material to encapsulate a structural base in ceramic tile surfaces.

2. Description of Prior Art

Homeowners, as well as businesses, frequently request built-in, or permanently applied ceramic based utility shelves to support toiletries, bathing implements, soaps, etc. within easy or convenient grasp of the user in tiled areas. Currently these “shelves” are limited to a pre-finished selection that can sometimes “get close” or be similar to the surrounding materials in color or texture but are only available in a corner type configuration. They are also generally available in one or two predetermined sizes and therefore limit functionality. These types of shelves also tend to break or pull out of the wall after time so are generally an inferior solution. They do, however, meet the basic function for which they are designed. A better method used to achieve a built-in look that does use a job-site applied finish material, is a recessed space projecting into the wall cavity between the framing members. Unfortunately, this provides an extremely limited physical size and functionality due to preexisting framing limitations such as the depth of the wall cavity and/or structural framing member placement within the existing wall. This particular method of installation can also be very time consuming to produce, and risky to the installer due to the inherent potential for leakage within the wall cavity. Waterproofing integrity must not only be maintained within the cavity but around the perimeter as well, due to the waterproofing membrane of the wall having to be cut to allow the recess area to be produced.

### OBJECTS AND ADVANTAGES

It suffices to say that a better option should exist to the methods described in the previous section. The invention that I propose will accomplish this goal. The advantages of the structural support ledge include the following points:
(A) Provides a structural substrate which is non-conducive to corrosion or structural failure of any kind.
(B) A pre-calculated stress load that will not vary when used with specified fasteners.
(C) A convenient and adaptable support which defines the shape and functional load area.
(D) The provision of a uniform tileable surface for any design conditions.
(E) The elimination of any waterproofing alteration and ultimate protection of damage susceptible wood framing members.
(F) Unlimited available service space due to length flexibility, adaptable on site.
(G) An extremely rapid installation process that is flexibly designed for installation in any “new” construction project (finish wall tile not yet applied).
(H) A provision to easily allow the contractor to adhere the finish surfacing material to the structural ledge.
(I) The convenience of a “stockable” item which is readily available in various sizes, widths and/or shapes.

Further objects and advantages stem from basic product durability and ease of handling. Other advantages will become apparent through a consideration of the ensuing descriptions and drawings.

### DRAWING FIGURES

FIG. 1 shows base unit with straight front edge.

FIG. 2 shows an isometric view of finished unit.

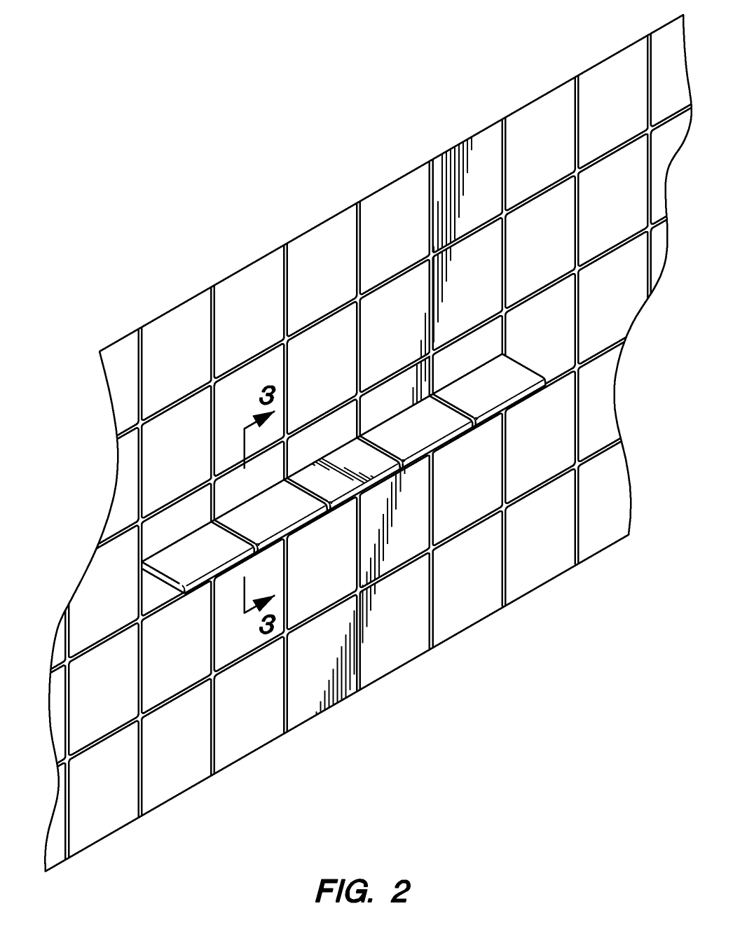

FIG. 3 shows a cross section view of tiled unit.

### REFERENCE NUMERALS IN DRAWINGS

1. base unit
2. integral mounting flange
3. mounting holes
4. adhesive penetration holes
5. tile
6. bonding agent
7. grout

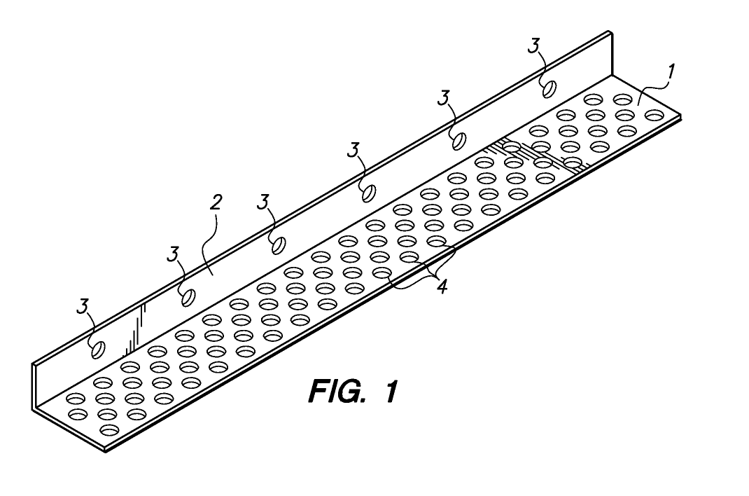

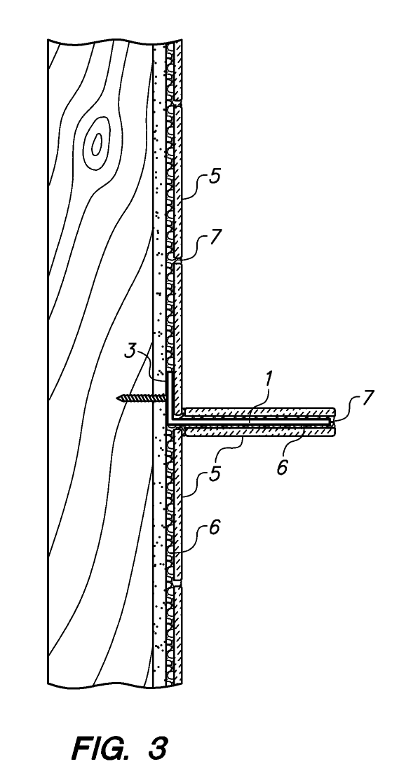

### Description—FIGS. 1 and 3

A typical embodiment of the invention is illustrated in FIG. 1 (isometric view of top side as seen from front edge). The invention is one piece, structurally calculated, and made of a non-corrosive, rigid material that is pre-formed to a specific size and shape, called namely the base unit (1).

The base unit (1) can be produced from several materials through various production processes, including: corrosion-resistant sheet metal which can be stamped or folded; aluminum or brass, both of which can be cast, stamped or folded; plastic, through injection molding or otherwise; and various other materials.

Mounting holes (3) are provided in specific locations of the integral mounting flange (2) to allow quick and easy fastening of the base unit(1) to structural perpendicular wall elements at any elevation or location desired.

Adhesive penetration holes (4) are placed in a specific pattern on the base unit (1) to allow direct bonding of finish elements, to both exposed surfaces of the base unit (1) and to each other.

Additional embodiments are shown in FIG. 3. A cross-sectional view from one side, either left or right (both views are typical). FIG. 3 shows the base unit (1) mounted to a perpendicular plane by way of the integral mounting flange (2) and mounting holes (3), and with the addition of an installer-provided finish material, tile (5) adhered to both top and bottom surfaces of the base unit (1) by utilizing a bonding agent (6) through the adhesive penetration holes (4), and grout (7) to provide a completed form of installation of my invention.

There are various possibilities with regard to the shapes, sizes, and basic configuration that can be achieved or imagined, by the inventions designed use. The thickness variations of the bonding agent used, or the possible layering of other thickening materials by the installer, as well as basic size, shape, or surface area variations can easily provide design alternatives for the finished appearance desired.

From the description above, a number of novel advantages become evident:
(A) The use of a non-corrosive, non-porous material virtually eliminates structural failure or subsequent movement.
(B) The elimination of any waterproofing, requirement to protect the structural components of the structural ledge, as well as the preservation of vertical surface waterproofing membranes greatly reduces the risk of water penetrating to susceptible wall framing members.
(C) A secure, rapid installation system that not only allows the installer to become more productive, but also provides a less expensive means by which to provide a convenient customizable feature to all consumers.
(D) A rapid, effective and secure method of bonding finish surface material to encapsulate the structural unit which will match or contrast with surrounding area as the installer or customer desires.
(E) Allowing the structural ledge to act as a visual aid in the placement of the shelf, simply by placing at any elevation, or location, prior to installation for the consumer's visualization and approval.
(F) A flexible system of installation for many conditions encountered in the project field, as well as virtually unlimited design control by the installer or project specifier.

### Operation—FIGS. 1 and 3

The manner of using this structural support ledge for its designed use, listed above, is as follows: (The unit is designed to be mounted prior to project completion.) The selection of depth, length, and shape of the base unit (1) will be made by the consumer. The installer/contractor then easily modifies the unit to meet the request of the consumer, such as cutting to a specified length or width, and determines the elevation and/or location for the unit. This can be done simply by moving the unit anywhere until the aesthetic or functional location is found. The mounting hole locations are then marked on the surface of which the base unit is to be installed and drilled with a drill bit of the specified size. The fasteners are applied through the mounting holes (3), located in the integral mounting flange (2) of the base unit (1) (see FIG. 1 or 3) to the vertical wall surface(s). The base unit (1) then provides a uniform even surface for the direct application of tile (5) or other finish material. The finish material is bonded to the top and bottom of the base unit (1) and each other, by way of a bonding agent (6) which passes through the adhesive penetration holes (4). Bonding agent (6) will also be used to adhere finish tile (5) or other surfacing material, to the face of the integral mounting flange (2). All finish materials will then have grout (7) applied to all surfaces to fill joints and complete encapsulating base unit (1) and integral mounting flange (2).

### SUMMARY, RAMIFICATIONS, AND SCOPE

Accordingly, the reader will see that the tile ready, self-supporting base unit, of this invention can be utilized in such a fashion as to allow for customization of tile projects by means of a safe, rapid, secure, and flexible system. The invention provides: ease of use and installation; a stable, non-corroding base, which combines the structural component of the shelf, with a convenient pre-determined shape; substantial saving of installation time through the elimination of several, currently necessary elements (waterproofing materials, alteration to structural wall framing members, or blocking for mechanical fastening of components; built-in custom design features, such as size and shape and the ability to use any type, style, or color finish material approved for an its intended use; and a visual aid that most consumers require to understand the full benefit of placement and design.

Although the description above contains much specificity, these should not be construed as limiting the scope of the invention but as merely providing illustrations of some of the presently preferred embodiments of this invention. Examples can range from shapes other than those shown; adhesive penetration holes of different configuration or spacing; an integral mounting flange of varying size or elevation; fastening systems for different surfaces, etc, as well as the possibility of utilizing this invention without the need to apply any finish surface material and leaving it in its raw, unfinished state.

Thus the scope of the invention should be evaluated by the appended claims and their legal equivalents rather than by the examples I have offered here.

I claim the tile-ready structural support ledge as:

1. a structural support ledge for ceramic tile shelves, comprising in combination:
a horizontal base unit (1) having an integral mounting flange (2) which extends as a perpendicular plane for abutting with a structural wall;
mounting holes (3) within said integral mounting flange (2) to receive fastening means for securely fastening the base unit (1) to said structural walls extending substantially perpendicular to the horizontal plane

2. the structural support ledge of claim 1 further including, adhesive penetration holes (4) within the base unit (1) and/or integral mounting flange (2) to allow uniform bonding of finish materials to parallel substrates;

3. the structural support frame of claim 2 wherein, said base unit (1) is arcuate.
